(19) United States
(12) Patent Application Publication
(10) Pub. No.: US 2017/0180741 A1
(43) Pub. Date: Jun. 22, 2017

(54) VIDEO CHROMINANCE INFORMATION CODING AND VIDEO PROCESSING

(71) Applicant: Ross Video Limited, Iroquois (CA)

(72) Inventors: David Allan Ross, Nepean (CA); Nigel William Spratling, Reinholds, PA (US); Trevor Charles May, Ottawa (CA); Paul William Ernest, Lynnfield, MA (US); Greg Carlson, Chelmsford, MA (US)

(73) Assignee: Ross Video Limited, Iroquois (CA)

(21) Appl. No.: 14/976,908

(22) Filed: Dec. 21, 2015

(51) Int. Cl. H04N 19/186; H04N 19/44; H04N 5/225; H04N 19/182

(52) U.S. Cl. CPC H04N 19/186; H04N 19/182; H04N 19/44; H04N 5/225

(57) ABSTRACT

Luminance information and a subset of chrominance information associated with a video signal are encoded into a first encoded video signal. The subset of chrominance information does not include all of the received chrominance information. At least the remaining chrominance information that is associated with the video signal but is not encoded into the first encoded video signal is encoded into a second encoded video signal. The second encoded video signal could include all of the chrominance information, and not only the remaining chrominance information. In either case, a full set of chrominance information for the video signal is encoded.

### FIELD

The present disclosure relates generally to video signal coding and processing and, in particular, to coding and processing of chrominance information. Aspects of the disclosure relate to video standards and to broadcast video equipment and systems, including chroma key systems such as virtual sets, cameras, and video production switchers.

### BACKGROUND

Y′CbCr is a method of color encoding that is used in digital video. Y′ is the luminance (luma) component, Cb is the blue-difference chrominance (chroma) component and Cr is the red-difference chroma component. For example, for High Definition TeleVision (HDTV) video formats, the following definitions hold:

Y′=0.2126R+0.7152G+0.0772B

Cb=B−Y′

Cr=R−Y′,

where R, G and B refer to Red, Green and Blue color components of an original image.

Some video coding approaches compress video signals in order to lower required video bandwidth, by limiting the bandwidth of the chroma information. A loss of chroma bandwidth is acceptable because the human eye is less sensitive to chroma position, resolution, and movement than it is to luma position, resolution and movement. However, in such approaches the Cb and Cr components are typically bandwidth limited at the video source (camera). It is therefore impossible to recover all chroma information that is lost at the source.

### SUMMARY

According to an aspect of the present disclosure, a video encoder includes: an interface to receive luminance information and chrominance information that is associated with a video signal; a first encoder to encode the received luminance information and a subset of the received chrominance information into a first encoded video signal, the subset of the chrominance information including less than all of the received chrominance information; and a second encoder to encode, into a second encoded video signal, at least the received chrominance information that is not encoded into the first encoded video signal.

In an embodiment, the second encoder is configured to encode all of the received chrominance information into the second encoded video signal.

The second encoder could be configured to map the received chrominance information to two data streams and to interlace the two data streams to generate the second encoded video signal.

The second encoder could instead be configured to map the received luminance information to a first data stream; to map, to a second data stream, the received chrominance information that is not encoded into the first encoded video signal; and to interlace the first data stream and the second data stream to generate the second encoded video signal.

In an embodiment, a video camera includes: an image detector to capture video image information for the video signal; a color space converter, operatively coupled to the image detector, to generate luminance information and chrominance information from the video signal; and a video encoder as disclosed herein, operatively coupled to receive the luminance information and the chrominance information from the color space converter.

A video production system is also provided, and includes such a video camera and a video processor, operatively coupled to the video camera, to receive the first encoded video signal and the second encoded video signal from the video camera, to decode chrominance information from the second encoded video signal, and to use the chrominance information that is decoded from the second encoded video signal in video processing for the video signal.

The video processor could be further configured to decode chrominance information from the first encoded video signal, and to use the chrominance information that is decoded from the first encoded video signal and the chrominance information that is decoded from the second encoded video signal in the video processing for the video signal.

In an embodiment, the video processor includes a video keyer and the video processing includes alpha generation for video keying.

A method according to another aspect includes: receiving luminance information and chrominance information that is associated with a video signal; encoding the received luminance information and a subset of the received chrominance information into a first encoded video signal, the subset of the chrominance information including less than all of the received chrominance information; and encoding, into a second encoded video signal, at least the received chrominance information that is not encoded into the first encoded video signal.

In an embodiment, the encoding into a second encoded video signal involves encoding all of the received chrominance information into the second encoded video signal.

The encoding into a second encoded video signal could involve mapping the received chrominance information to two data streams and interlacing the two data streams to generate the second encoded video signal.

The encoding into a second encoded video signal could instead involve: mapping the received luminance information to a first data stream; mapping, to a second data stream, the received chrominance information that is not encoded into the first encoded video signal; and interlacing the first data stream and the second data stream to generate the second encoded video signal.

The method could also include capturing the video signal and generating the luminance information and the chrominance information from the video signal.

In an embodiment, the also involves receiving the first encoded video signal and the second encoded video signal, decoding chrominance information from the second encoded video signal, and using the chrominance information that is decoded from the second encoded video signal in video processing for the video signal.

The method could additionally include decoding chrominance information from the first encoded video signal. In this case, using chrominance information in video processing could involve using both the chrominance information that is decoded from the first encoded video signal and the chrominance information that is decoded from the second encoded video signal in the video processing for the video signal.

The video processing could include alpha generation for video keying.

Such a method, and/or possibly other methods disclosed herein, could be embodied, for example, in a non-transitory computer-readable medium storing instructions which when executed by a processor cause the processor to perform the method.

According to another aspect, a video decoder includes an interface to receive a first encoded video signal and a second encoded video signal. The first encoded video signal has encoded therein luminance information associated with a video signal and a subset of chrominance information associated with the video signal. The subset of chrominance information includes less than all chrominance information associated with the video signal, and the second encoded video signal has encoded therein at least chrominance information that is associated with the video signal but not encoded into the first encoded video signal.

The video decoder also includes: a first decoder, operatively coupled to the interface, to decode at least the luminance information from the first encoded video signal; and a second decoder, operatively coupled to the interface, to decode from the second encoded video signal at least the chrominance information that is associated with the video signal but not encoded into the first encoded video signal. All of the chrominance information associated with the video signal is decoded either from the second encoded video signal by the second decoder, or partially from the first encoded video signal by the first decoder and partially from the second encoded video signal by the second decoder.

In an embodiment, the second encoded video signal has all of the chrominance information that is associated with the video signal encoded in it, and the second decoder is configured to decode all of the chrominance information that is associated with the video signal from the second encoded video signal.

A video processing system could include such a video decoder, and a video processor, operatively coupled to the video decoder, to receive all of the chrominance information associated with the video signal, and to use the decoded chrominance information that is associated with the video signal in video processing for the video signal.

The video processor, as noted above, could include a video keyer, and the video processing could include alpha generation for video keying.

A method according to another aspect includes: receiving a first encoded video signal and a second encoded video signal, the first encoded video signal having encoded therein luminance information associated with a video signal and a subset of chrominance information associated with the video signal, the subset of chrominance information including less than all chrominance information associated with the video signal, the second encoded video signal having encoded therein at least chrominance information that is associated with the video signal but not encoded into the first encoded video signal; decoding the luminance information from the first encoded video signal; and decoding all of the chrominance information associated with the video signal from either from the second encoded video signal, or partially from the first encoded video signal and partially from the second encoded video signal.

In an embodiment, the second encoded video signal has all of the chrominance information that is associated with the video signal encoded in it, and decoding all of the chrominance information involves decoding all of the chrominance information from the second encoded video signal.

The method could also include: using all of the chrominance information that is associated with the video signal in video processing for the video signal.

The video processing could include alpha generation for video keying.

A method according to yet another includes: receiving chrominance information that is associated with a video signal but is not encoded into a first encoded video signal with luminance information that is associated with the video signal; and encoding the received chrominance information into a second encoded video signal.

Other aspects and features of embodiments of the present disclosure will become apparent to those skilled in the art upon review of the following description.

### BRIEF DESCRIPTION OF THE DRAWINGS

Examples of embodiments of the invention will now be described in greater detail with reference to the accompanying drawings.

FIG. 1 is a block diagram representation of luma and chroma information for a pixel pair according to 4:2:2 video coding.

FIG. 2 is a block diagram representation of 4:2:2 video coding data streams.

FIG. 3 is a block diagram of a video camera implementing 4:2:2 video coding.

FIG. 4 is a representation of a video image.

FIG. 5 is a block diagram of a video production system that uses 4:2:2 video coding.

FIG. 6 is a block diagram representation of video keying.

FIG. 7 is a block diagram of a chroma keyer that uses 4:2:2 video coding.

FIG. 8 is a representation of a key alpha generated using 4:2:2 video coding.

FIG. 9 is a representation of a chroma keying result using the key alpha of FIG. 8.

FIG. 10 is a block diagram representation of example video coding data streams according to an embodiment.

FIG. 11 is a block diagram of an example video camera implementing an embodiment.

FIG. 12 is a block diagram of an example chroma keyer according to an embodiment.

FIG. 13 is a block diagram of an example video production system implementing an embodiment.

FIG. 14 is a representation of a key alpha generated according to an embodiment.

FIG. 15 is a representation of a chroma keying result using the key alpha of FIG. 14.

FIGS. 16 and 17 are flow charts illustrating example methods.

### DETAILED DESCRIPTION

As noted above, some video coding approaches compress video signals in order to lower required video bandwidth, by limiting the bandwidth of the chroma information. So-called “4:2:2” video coding, for example, is a subsampling scheme and digital video encoding method specified in Appendix D of SMPTE 274M from the Society of Motion Picture & Television Engineers (SMPTE).

This and similar schemes are represented as a three part ratio, J:a:b (4:2:2, for example) that describes the number of luma and chroma samples in a conceptual region that is J pixels wide, and 2 pixels high. The parts are (in their respective order):
J: horizontal sampling reference (width of the conceptual region). Equal to 4 times the subcarrier frequency of the Y′ component. Usually, 4.
a: number of chroma samples (Cr, Cb) in the first row of J pixels.
b: same as ‘a’, or zero (0) which indicates that the Cb Cr are subsampled 2:1 vertically.

Video encoded with 4:2:2 coding has the chroma information encoded at half the horizontal resolution of an original video image. That is, exactly half of the horizontal chroma information is discarded in this subsampling scheme. Each pixel contains full Y′ information, but alternating pixels contain only Cb or Cr information.

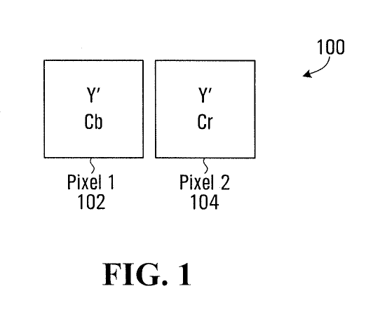

FIG. 1 is a block diagram representation of luma and chroma information for a pixel pair according to 4:2:2 video coding. In the case of 4:2:2, the Cb and Cr signals are horizontally subsampled by a factor of two with respect to the Y′ component as shown in FIG. 1. Cb and Cr samples, when subsampled, are cosited with even-numbered Y′ samples. The subsampled Cb and Cr signals are time-multiplexed on a sample by sample basis in the order of Cb and Cr. In the example 4:2:2 pixel pair 100, pixel 1 contains a full Y′ sample and a Cb sample as shown at 102. Pixel 2 contains a full Y′ sample and a Cr sample as shown at 104. This loss of chroma information, or limitation of chroma bandwidth, is acceptable because the human eye is less sensitive to chroma position, resolution, and movement than it is to luma position, resolution and movement.

4:2:2 coding is used in many modern broadcast video formats, including: 480i, 576i, 720p50, 720p59.94, 1080i50, 1080i59.94, 1080p50, and 1080p59.94. With this coding method, 1080p video formats can be transmitted on a 3 Gb/s serial link, for example. Other types of links could also or instead be used.

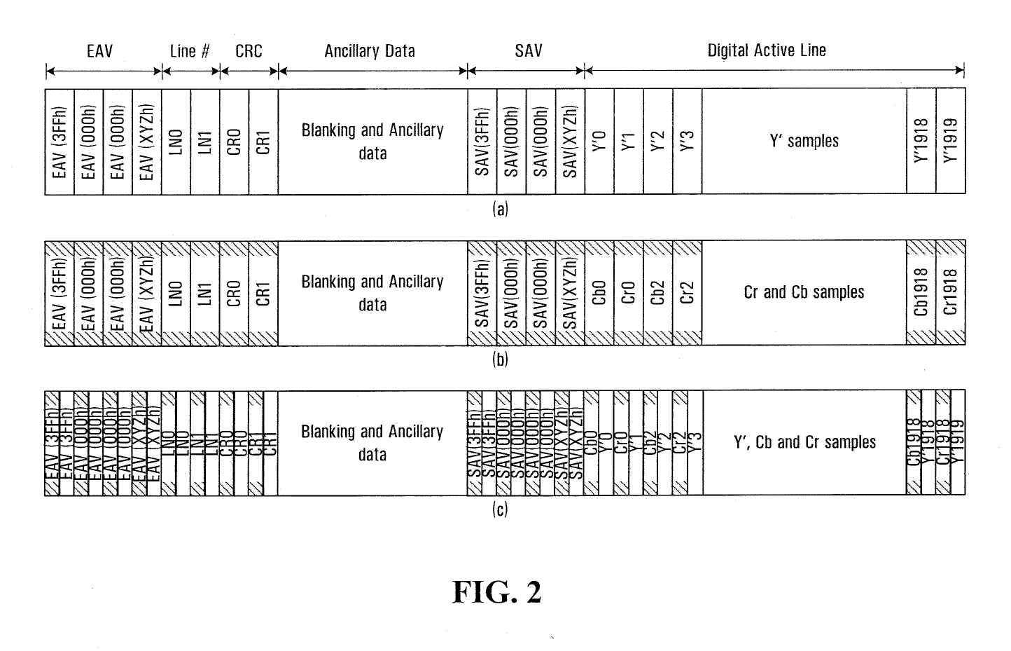

FIG. 2 is a block diagram representation of 4:2:2 video coding data streams. In FIG. 2, (a) represents “data stream one” and (b) represents “data stream two” as specified in SMPTE 425M. These data streams are multiplexed or interlaced to generate the encoded video signal shown at (c). Data stream one at (a) includes full luma information in the Digital Active Line, but data stream two at (b) includes only partial subsampled chroma information, with chroma samples for even-indexed pixels in the example shown. The EAV, Line number, CRC, Ancillary data, and SAV sections shown in FIG. 2 are all compatible with SMPTE 425M. The data pattern shown in FIG. 2 repeats in a complete digital video data stream. The cross-hatching shown in FIG. 2 is intended simply to distinguish between data that originates from data stream one (a) and data that originates from data stream two (b) in the interlaced data stream (c).

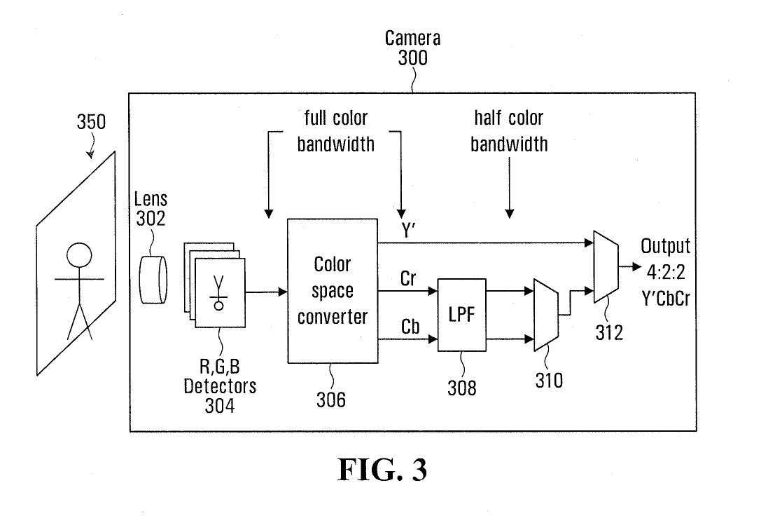

FIG. 3 is a block diagram of a video camera implementing 4:2:2 video coding. The video camera 300 includes a lens 302, detectors 304, a color space converter 306, a Low Pass Filter (LPF) 308, and multiplexers 310, 312. For completeness, a representation of talent (a television host, for example) on monochromatic screen (typically green or blue) is also shown at 350.

Cameras of the type shown in FIG. 3 produce 4:2:2 encoded video signals in compliance with SMPTE 274M Appendix D. The camera lens 302 focuses an image onto photosensitive detectors 304, including one each for Red, Green, and Blue. The R, G, and B detector outputs, in RGB color space, are converted into Y′CbCr in Cb Cr color space by the color space converter 306 using 4:4:4 encoding. An example transfer function for this conversion is provided above, although other transfer functions are possible.

Thus, in FIG. 3, a foreground image (the talent at 350) is captured by the camera lens 302 and encoded as RGB video by the detectors 304. This is color space converted into Y′CbCr encoding by the color space converter 306. The Cb and Cr components are filtered using the LPF 308, and then are subsampled by the multiplexer 310 by discarding every second pixel. This removes half of the horizontal chroma information for each component, reducing chroma bandwidth by half. The Y′ signal passes through without subsampling. The resulting subsampled chroma components are multiplexed by the multiplexer 310 and added to the full bandwidth Y′ component by the multiplexer 312 to generate the 4:2:2 encoded output.

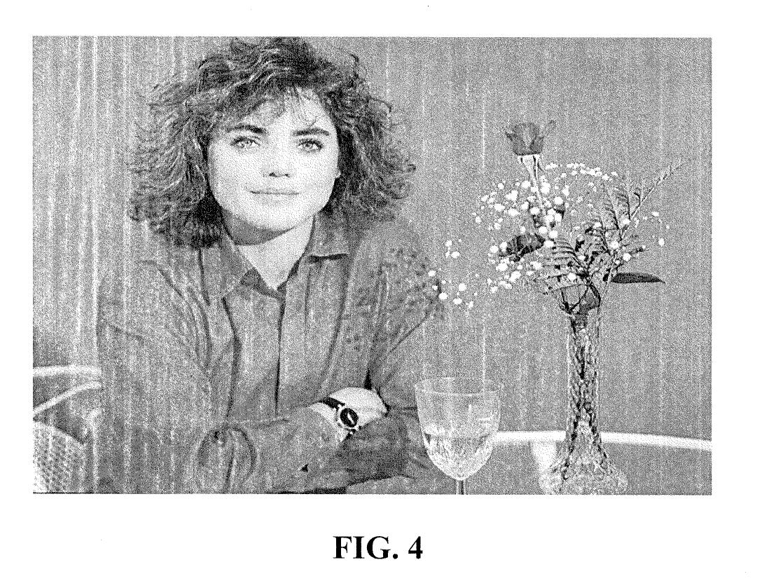

FIG. 4 is a representation of a video image, which includes talent against a monochromatic (typically blue or green) screen. This is a typical shot from a virtual set camera. In a color image, the model would be shown in front of a uniform monochromatic background.

A virtual set is a video studio environment where actors (talent) perform in front of a specially painted monochromatic background, which is usually blue or green. During production, the monochromatic background is removed using video processing and replaced with a completely different background, either computer generated or video from another source. This process is called chroma keying. Using this method, the talent can be virtually placed in any background, real or imagined.

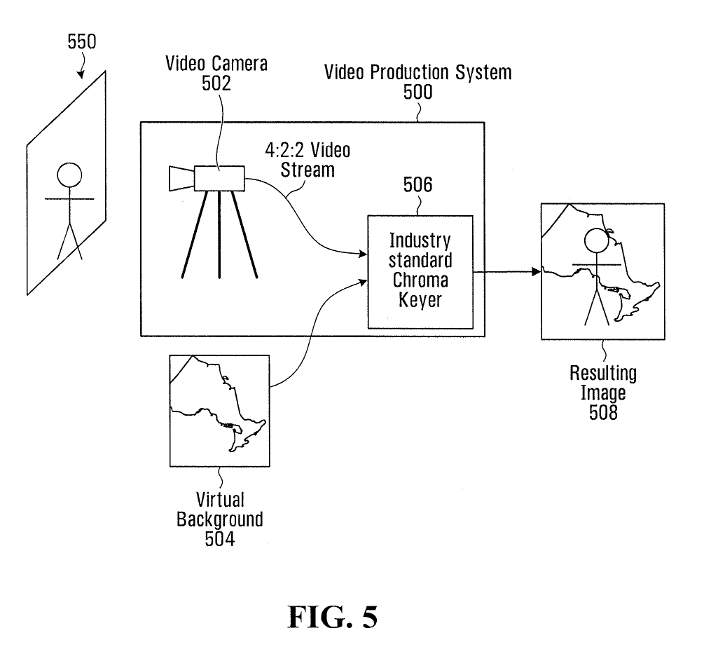

FIG. 5 is a block diagram of a video production system that uses 4:2:2 video coding. The video production system 500 is shown with other elements of a virtual set, including talent on a monochromatic (typically blue or green) screen at 550, as well as a virtual background 504 and the resulting image 508. The talent is captured in front of the monochromatic screen at 550 with an industry standard 4:2:2 camera 502. The captured video is keyed over the virtual background 504 using an industry standard chroma keyer 506.

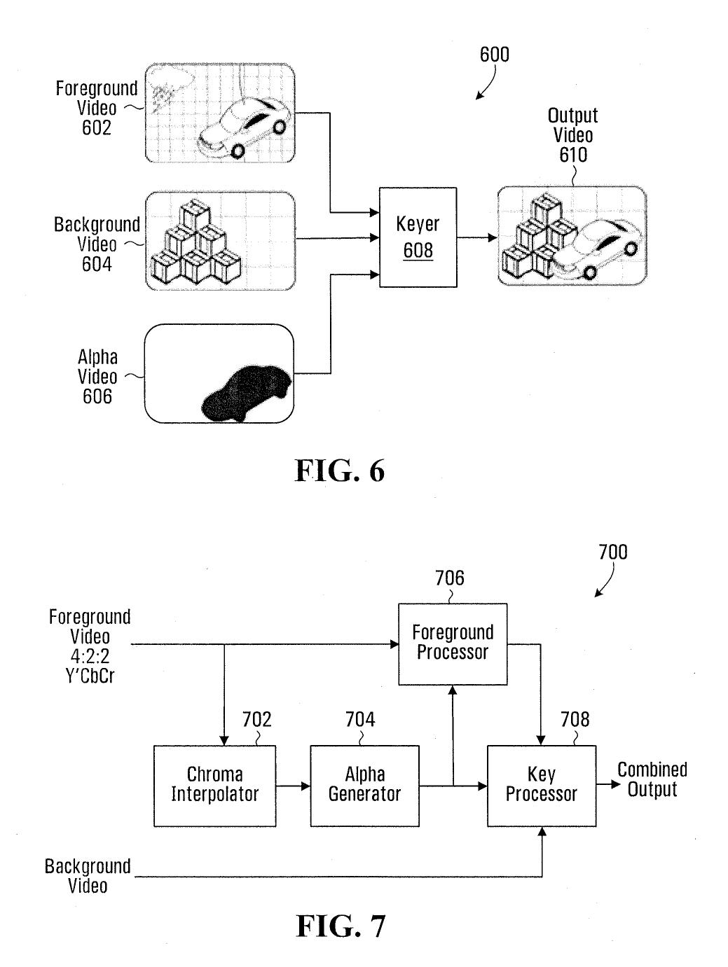

FIG. 6 is a block diagram representation 600 of video keying. Video keying is a video processing technique whereby two input video streams are combined together to create an output video stream. The first input video stream is called the ‘foreground video’, or ‘foreground’, and is shown at 602. The second input video stream is called the ‘background video’, or ‘background’, and is shown at 604. The portion of interest of the foreground video is layered on top of the background video using the keying process. The portion of interest is identified by a third input video stream called the ‘key alpha’ or ‘alpha’. The luminance of the alpha signal determines on a pixel by pixel basis which portion of the foreground video is to be isolated and layered on top of the background video. The result of this layering is the output video 610.

In FIG. 6, the foreground video 602 and the background video 604 are sent to the keyer 608. The alpha video 606 defines the portion of the foreground video that is to be layered over top of the background video (the dark area in this case). The keyer 608 uses the alpha to choose between background video and foreground video on a pixel by pixel basis, layering the foreground video over top of the background video in accordance with the alpha 606. The output video 610 has the portion of the foreground video 602 that is selected by the alpha 606 layered over top of the background video 604 as shown.

Chroma keying is a keying technique in which video pixels in the foreground video that have a pre-selected chroma are removed and replaced with the background video. Chroma keys are used to replace the monochromatic background with a completely different background. FIG. 7 is a block diagram of a chroma keyer that uses 4:2:2 video coding.

The industry standard chroma keyer 700 shown in FIG. 7 includes a chroma interpolator 702, an alpha generator 704, and foreground and key processor blocks 706, 708. The foreground video contains the talent in front of the monochromatic screen. The foreground video chroma information (the Cb and Cr content) is assumed to be previously sub-sampled, as indicated by the 4:2:2 label in FIG. 7. This video feed is sent to the chroma interpolator 702 where missing chroma information caused by the 4:2:2 video encoding is replaced with an algorithmic approximation of the original chroma information. The chroma information in the 4:2:2 encoded video signal is thus interpolated by the chroma Interpolator 702 in an attempt to re-generate missing chroma information that was discarded during encoding.

The resulting full chroma bandwidth video output of the chroma interpolator 702 is analyzed by the alpha generator 704 and used to generate the chroma key alpha based on pixel color. The alpha generator 704 generates the alpha by identifying pixels that are a pre-selected color, usually the color used in the monochromatic screen, and assigning these pixels to the background. The remaining pixels are assigned to the foreground. This alpha, along with the foreground video encoded in Y′CbCr format, is used by the foreground processor 706 to generate the foreground image. Finally, the key processor 708 takes both the intended background and the processed foreground image and combines them together to create the final output. The key processor 708 uses the key alpha to remove the monochromatic portion of the foreground video and layer the result over the background video. This key processor 708 thus uses the key alpha to decide whether each pixel is foreground, background, or a mix, on a pixel by pixel basis.

Because the Cb and Cr signals are bandwidth limited at the video source (camera) in 4:2:2 coding, it is impossible to recover all information that is lost in the source filtering and subsampling of the chroma channels. This may make it difficult to produce a high resolution key alpha, which has a dramatic impact on the quality and realism of the combined output. Alpha signals generated using these methods can have a high degree of horizontal aliasing.

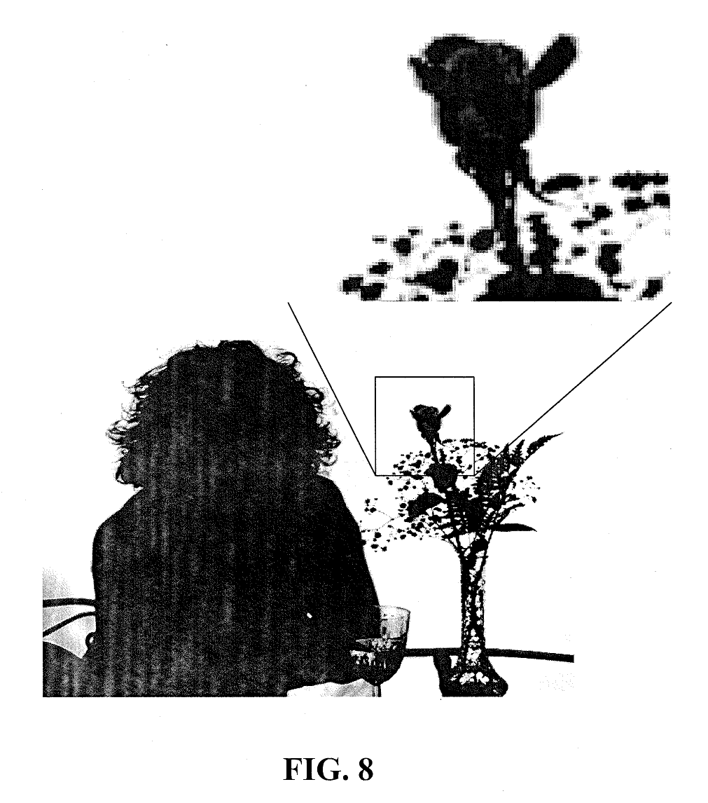

FIG. 8 is a representation of a key alpha generated using 4:2:2 video coding, and shows horizontal aliasing. This drawing shows the alpha generated by an industry standard chroma keyer using a 4:2:2 video source. A resulting image that is generated using the alpha in FIG. 8 would show the effect of missing color information at the edges of foreground objects. The aliasing effects caused by missing horizontal chroma data are clearly visible, for example, in the expanded portion of FIG. 8.

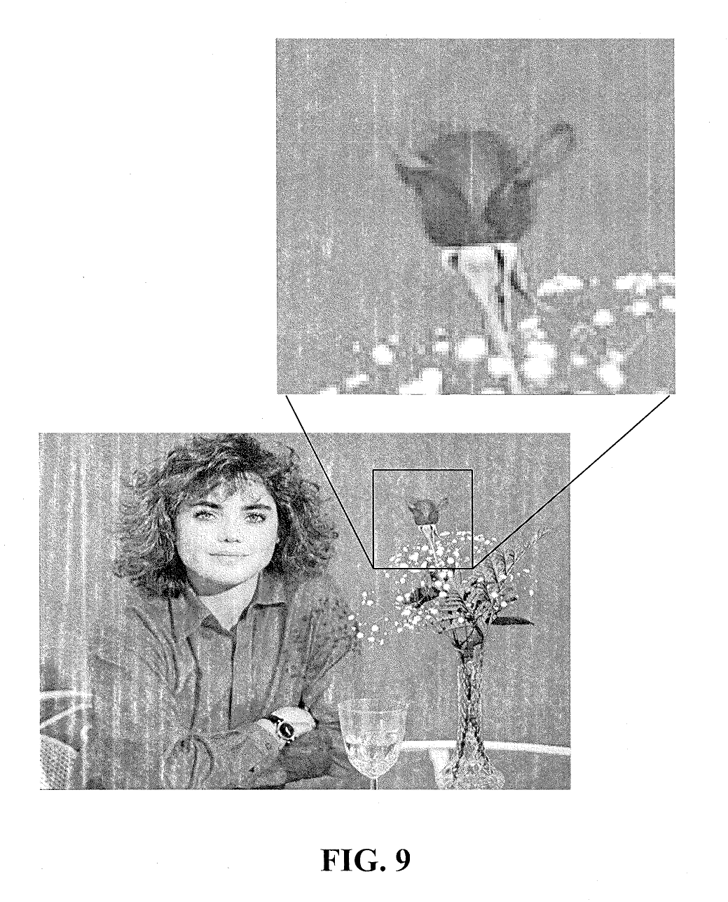

Horizontal aliasing may result in a final image that has many defects along the edges of a foreground object. FIG. 9 is a representation of a chroma keying result using the key alpha of FIG. 8. This drawing is a test image or frame of video that was encoded in 4:2:2 video and passed through an industry standard chroma keyer. The resulting test frame shows the effect of the aliased alpha signal in the form of loss of detail at edges of the flower.

A new method of chroma keying is proposed herein. The new method utilizes full bandwidth chroma information, which may help avoid horizontal aliasing errors that are common with systems designed around industry standard 4:2:2 video. Using full bandwidth chroma information may provide a superior combined image with heightened realism that requires fewer subsequent image processing steps to correct for horizontal aliasing errors.

Aspects of the present disclosure include, for example:

1. A novel digital video encoder and encoding method that encode full bandwidth chroma data without subsampling, which can be transported using industry standard 3 Gb/s infrastructure. One encoding method is called 0:4:4 encoding herein, for ease of reference. The 0:4:4 designation is intended to convey the notion that full chroma information is encoded without luma information, and does not follow the standard nomenclature noted above for 4:2:2 coding. Another encoding method is also disclosed, and is referred to herein as 4:2′:2′ encoding.
2. A novel full bandwidth chroma video camera that, in addition to generating industry standard 4:2:2 video, also generates a second encoded video signal, such as a full chroma bandwidth 0:4:4 encoded video signal using a 0:4:4 encoding method or a 4:2′:2′ encoded video signal.
3. A novel full bandwidth chroma keying technique that utilizes both the industry standard 4:2:2 video and a second encoded video signal such as a 0:4:4 or a 4:2′:2′ encoded video signal, to generate a chroma key that may be visibly superior and use fewer resources compared to key generation using only a 4:2:2 encoded video signal.
4. A novel virtual set environment that utilizes, for example, 0:4:4 or 4:2′:2′ video coding, a full bandwidth chroma video camera, and a full bandwidth chroma keyer to generate virtualized productions which may have heightened realism compared to standard 4:2:2-based video systems.

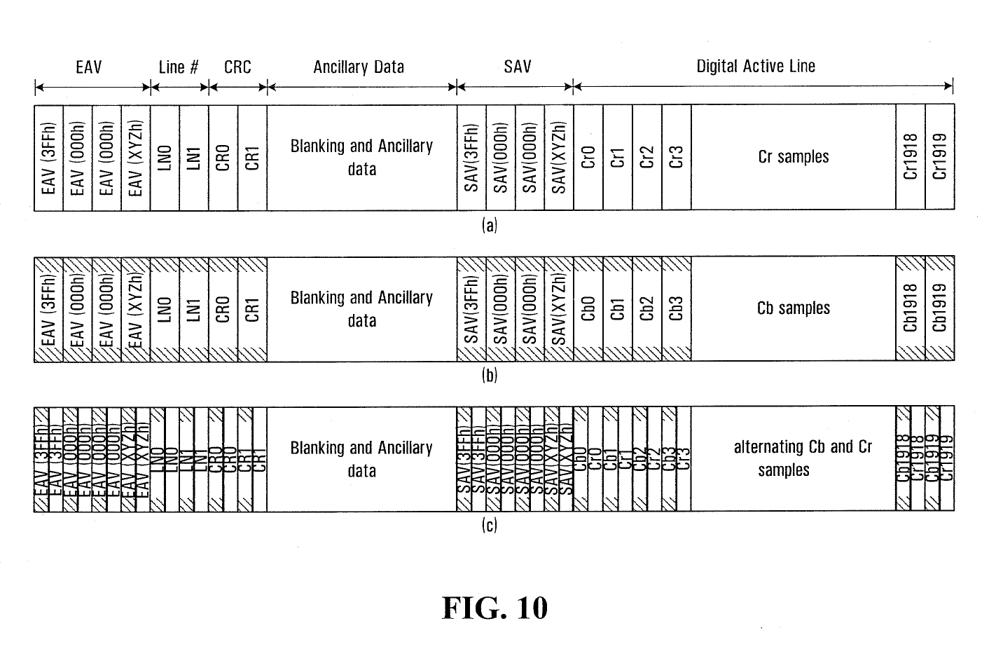

FIG. 10 is a block diagram representation of example video coding data streams according to an embodiment, specifically full bandwidth 0:4:4 video coding. This drawing shows how 0:4:4 video could be encoded in a 1080p50 or a 1080p59.97 compatible data stream, by way of example. This encoding encodes chroma information at full bandwidth, at the expense of all luma information.

In FIG. 10, the chroma information is mapped to two virtual interface data streams as follows:

Data stream one (a)=Cr0 Cr1 Cr2 Cr3 . . . .

Data stream two (b)=Cb0 Cb1 Cb2 Cb3 . . . .

These are combined into a single data stream (c), in a manner similar to the method described in SMPTE 425M section 4.2.1 for example, with the exception that all luma information is replaced with chroma information. The bit rate of the encoded video signal stream (c) is 3 Gb/s in an embodiment. The EAV, Line number, CRC, Ancillary data, and SAV sections shown in FIG. 10 are all compatible with SMPTE 425M. As noted above with reference to FIG. 2, the data pattern shown in FIG. 10 repeats in a complete digital video data stream, and the cross-hatching shown in FIG. 10 is intended simply to distinguish between data that originates from data stream one (a) and data that originates from data stream two (b) in the interlaced data stream (c).

On a comparison of FIGS. 2 and 10, it can be seen that this example 0:4:4 video coding generates an encoded video signal that is compatible with SMPTE 425M. 0:4:4 encoded video is compatible with industry standard video transmitters and receivers that are capable of transmitting and receiving 4:2:2 encoded video. 0:4:4 video coding can thus be mapped to every video format that utilizes 4:2:2 coding. This includes but is not limited to 480i, 576i, 720p50, 720p59.57, 1080i50, 1080i59.97, 1080p50, 1080p59.97, 2160p50, 2160p59.97, 2160p120, for example. However, 0:4:4 video is not subjected to any low pass filtering, subsampling, or color filtering as would typically be applied to the chroma information in 4:2:2 video.

0:4:4 video encoding, in combination with 4:2:2 video encoding, provides two encoded video signals which together provide full luma information and full chroma information associated with a video signal. Half of the chroma information is transmitted twice in this embodiment, since a 4:2:2 encoded video signal includes half of the original chroma information, and full chroma information (including the half of the original chroma information in the 4:2:2 video) is encoded into the 0:4:4 encoded video signal.

Other coding techniques are also possible. For example, according to a 4:2′:2′ encoding technique, luma information could be encoded along with only the chroma information that was not used to generate the 4:2:2 encoded video signal, in order to generate a second encoded video signal. In this case, the luma information is transmitted twice, in both the 4:2:2 encoded video signal and the 4:2′:2′ encoded video signal. The 4:2:2 encoded video signal and the 4:2′:2′ encoded video signal together provide full luma information and full chroma information. In a 4:2:2/4:2′:2′ system, the 4:2:2 encoded video signal could be as shown at (c) in FIG. 2, and the 4:2′:2′ encoded video signal could include the same luma information but odd chroma samples instead of the even chroma samples. Data stream two at (b) in this example could then also include the odd chroma samples.

In both of these examples, 0:4:4 encoded video signals and 4:2′:2′ encoded video signals are compatible with industry standard video transmitters and receivers that are capable of transmitting and receiving 4:2:2 encoded video.

Generating a second encoded video signal as disclosed herein is not simply a reversal of the compression that is used in 4:2:2 video coding. In embodiments disclosed herein, there are two encoded video signals instead of just the typical, single 4:2:2 encoded video signal. The two encoded video signals disclosed herein, together and in combination with each other, provide full luma information and full chroma information. For example, some disclosed embodiments use the additional second encoded video signal in addition to the industry standard 4:2:2 video signal, and thus two encoded video signals are used instead of just one. As noted above, at least some chroma information or luma information could actually be encoded twice, into both of the encoded video signals. Although this duplication of encoding and generation of a second encoded video signal increases the amount of information that is transferred between a video source and a video processor, this approach may be preferred to provide for compatibility of both of the encoded video signals with industry standard 4:2:2 transmitters and receivers.

A new digital video camera according to an aspect of the present disclosure produces two outputs, which in an embodiment are as follows:
Output 1—standard 4:2:2 encoded video
Output 2—a second encoded video signal, such as 0:4:4 or 4:2′:2′ encoded video.

Output 1 is intended to be used both with a full bandwidth chroma keyer and in non-virtual set applications. Output formats include but are not limited to 480i, 576i, 720p50, 720p59.57, 1080i50, 1080i59.97, 1080p50, 1080p59.97, 2160p50, 2160p59.97, 2160p120.

Output 2 is intended to be used with a full bandwidth chroma keyer and the novel virtual set environment as described herein. This output in 0:4:4 format includes no luma information, but includes full bandwidth chroma information as described above. In 4:2′:2′ format, this output includes luma information and the other half of the chroma information, which was not included in output 1. Output formats include but are not limited to 480i, 576i, 720p50, 720p59.57, 1080i50, 1080i59.97, 1080p50, 1080p59.97, 2160p50, 2160p59.97, 2160p120.

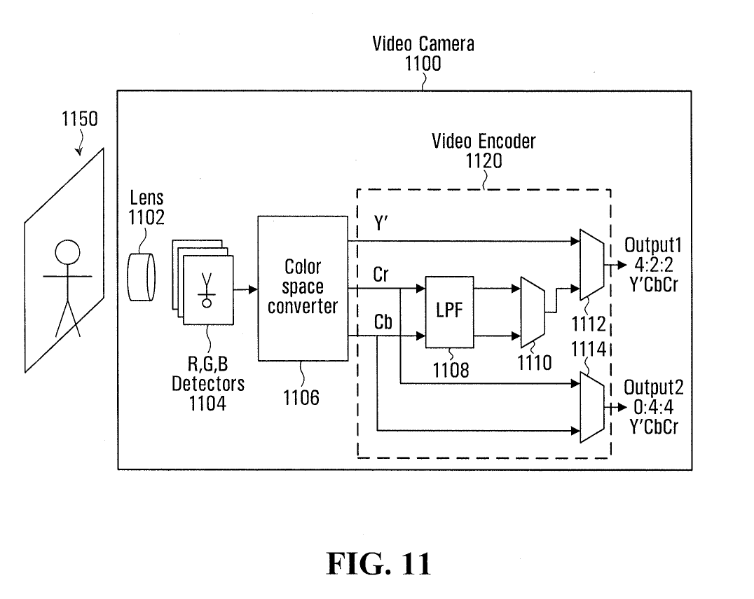

FIG. 11 is a block diagram of an example video camera implementing an embodiment. The example video camera 1100 is a full bandwidth chroma camera, and for completeness FIG. 11 also shows talent on a monochromatic (typically green or blue) screen at 1150.

The example video camera 1100 includes a lens 1102, detectors 1104, a color space converter 1106, an LPF 1108, and multiplexers 1110, 1112. These parts of the example video camera are also shown in the industry standard video camera 300 in FIG. 3, and operate as described above to generate 4:2:2 encoded video signals in the example shown.

However, the example video camera 1100 also includes a multiplexer 1114. In addition to generating an industry standard 4:2:2 video output, a second encoded video output such as a 0:4:4 video output is generated as Output 2. This is achieved by encoding the Cb and Cr information into a separate data stream. In the example shown, all of the Cb and Cr information is encoded by the multiplexer 1114 without first being subsampled. The multiplexer 1114 is coupled to the color space converter 1106 to receive all of the chroma information, before it is subsampled by the LPF 1108. This preserves all of the original chroma information in the 0:4:4 output.

4:2′:2′ encoding could be implemented using a set of two multiplexers as shown at 1110 and 1112, but with one of the multiplexers coupled to receive the half of the chroma information that is to be encoded into the second encoded video signal. This could involve a second LPF (not shown) that selects Cr and Cb samples that are not selected by the LPF 1108. Another possible option for 4:2′:2′ encoding could be to replace the LPF 1108 with a distributor that distributes chroma information for the 4:2:2 encoded video signal to a first set of Cr/Cb outputs coupled to the multiplexer 1110 and distributes remaining chroma information for the 4:2′:2′ encoded video signal to a second set of Cr/Cb outputs coupled to another multiplexer (not shown). Other implementations are also possible.

The LPF 1108 and the multiplexers 1110, 1112, 1114 are an example of one embodiment of a video encoder 1120. The video encoder 1120 receives luma information Y′ and chroma information Cb and Cr that is associated with a video signal. Y′, Cb, and Cr are received in the example shown through an interface to the color space converter 1106. This interface could be or include any of various types of physical connections and/or connectors, and the type of connection(s)/connector(s) could be implementation-dependent.

The video encoder 1120 generates two encoded video signals at Output 1 and Output 2. The LPF 1108 and the multiplexers 1110, 1112 could be considered a form of a first encoder to encode the received luma information Y′ and a subset of the received chroma information Cb and Cr into a first encoded video signal, which is a 4:2:2 encoded video signal in the example shown. The subset of the chroma information that is encoded into the first encoded video signal includes less than all of the received chroma information. For 4:2:2 encoding, only half of the chroma information is encoded into the 4:2:2 encoded video signal. The other half of the chroma information is removed by the LPF 1108 and by subsampling during 4:2:2 encoding.

The multiplexer 1114 is an example of a second encoder to encode, into a second encoded video signal at Output 2 in FIG. 11, at least the received chroma information that is not encoded into the first encoded video signal. For 0:4:4 encoding, all of the received chroma information Cb and Cr is encoded into the second encoded video signal. In this case, both the received chroma information that is encoded into the first encoded video signal and the remainder of the received chroma information that is not encoded into the first encoded video signal is encoded into the second encoded video signal. For 4:2′:2′ video encoding, only the received chroma information that is not encoded into the first encoded video signal is encoded into the second video signal, with the received luma information.

Therefore, at least the received chroma information that is not encoded into the first encoded video signal is encoded into the second encoded video signal. Other information, including the chroma information that is encoded into the first encoded video signal (for 0:4:4 encoding) or luma information (for 4:2′:2′ encoding) for example, could also be encoded into the second encoded video signal.

In an embodiment, the second encoder (multiplexer 1114) is configured to map the received chroma information to two data streams and to multiplex or interlace the two data streams to generate the second encoded video signal. In this case, the second encoder is configured to encode all of the received chroma information into the second encoded video signal. The second encoder could be implemented using hardware, firmware, one or more components that execute software, or some combination thereof. Electronic devices that might be suitable for implementing the multiplexer 1114 and/or other forms of a second encoder include, among others, microprocessors, microcontrollers, Programmable Logic Devices (PLDs), Field Programmable Gate Arrays (FPGAs), Application Specific Integrated Circuits (ASICs), and other types of “intelligent” integrated circuits. Such devices are configured for operation by executing software that is stored in an integrated or separate memory (not shown).

The second encoder such as the multiplexer 1114 could map the received chroma information to data stream one and data stream two as shown in FIG. 10 at (a) and (b), for example, and to combine the data streams into data stream (c) in accordance with SMPTE 425M. The actual data streams at (a) and (b) in FIG. 10 could be generated by the color space converter 1106, but mapped to data stream one and data stream two by the multiplexer 1114, which combines the data streams into the second encoded video signal.

For 4:2′:2′ encoding, the second encoder could be configured to map the received luma information to a first data stream such as data stream one. The second encoder could then map the received chroma information that is not encoded into the first encoded video signal to a second data stream, such as data stream two. Data stream one and data stream two could then be multiplexed or interlaced to generate the second encoded video signal at Output 2 in FIG. 11.

A video encoder 1120 could be part of a video capture or recording device, such as a video camera as shown in FIG. 11 by way of example. The detectors 1104 are an example of a possible implementation of an image detector to capture video image information for a video signal. The color space converter 1106 is operatively coupled to the image detector, in this example the detectors 1104, to generate luma information and chroma information from the video signal. The video encoder 1120 is operatively coupled to receive the luma information and the chroma information from the color space converter 1106.

A full bandwidth digital video chroma keyer uses two encoded video signals, such as 4:2:2 encoded video and 0:4:4 encoded video in one embodiment. The full bandwidth chroma information in the 0:4:4 video stream in this example, in conjunction with the original Y′ information in the 4:2:2 encoded video, can be used to create the chroma key alpha signal directly without chroma interpolation step. This allows for an implementation with fewer resources since chroma interpolation is not used.

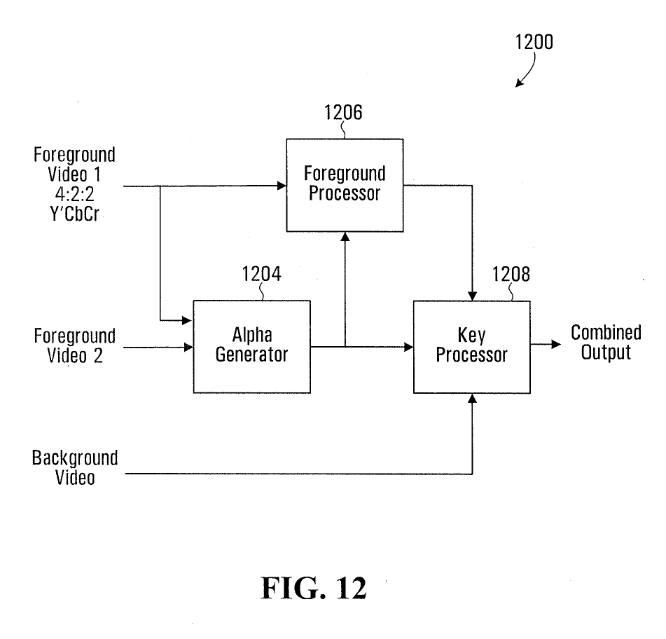

FIG. 12 is a block diagram of an example chroma keyer according to an embodiment. The example full bandwidth chroma keyer 1200 is similar to the chroma keyer 700 in FIG. 7, and includes an alpha generator 1204, and foreground and key processor blocks 1206, 1208. These elements could be implemented using hardware, firmware, one or more components that execute software, or some combination thereof. The above examples of electronic devices may also be suitable for implementing these elements.

There is no chroma interpolator in the example full bandwidth chroma keyer 1200. Chroma interpolation is eliminated because the chroma information is already at full bandwidth, in either the foreground video 2 input itself (in 0:4:4 encoding for example) or a combination of the foreground video 1 input and the foreground video 2 input (in 4:2′:2′ encoding for example).

The full bandwidth chroma information is analyzed directly by the alpha generator 1204 to generate the chroma key alpha based on pixel color. This alpha, along with the foreground video 1 input (encoded in Y′CbCr format) is used by the foreground processor 1206 to generate the foreground image. The key processor 1208 takes both the intended background and the processed foreground image and combines them together to create the final output. The key processor 1208 uses the key alpha to decide which pixel is foreground and which pixel is background.

In FIG. 12, the foreground processor 1206 and the alpha generator 1204 extract luma and chroma information from the foreground video 1 and foreground video 2 inputs. These elements could therefore be considered an example of a video decoder, with an interface for receiving a first encoded video signal (foreground video 1) and a second encoded video signal (foreground video 2). An interface in the context of a video decoder could be, for example, physical connectors to cables that carry serial data streams. Other types of connections and/or connectors are also possible.

A first decoder, which could be integrated with either or both of the alpha generator 1204 and the foreground processor 1206 or provided as a separate component in another embodiment, is operatively coupled to the interface to decode at least luma information from the first encoded video signal. The foreground video 1 input in FIG. 12, for example, is 4:2:2 video which has both luma information and chroma information encoded. Depending on whether 4:2:2 video is being used with 0:4:4 video or 4:2′:2′ video, the chroma information in the 4:2:2 video might or might not also be decoded from the first video signal.

A second decoder could similarly be integrated with the alpha generator 1204 or implemented separately. The second decoder is operatively coupled to the interface, to decode from the second encoded video signal (the foreground video 2 input in the example shown) at least chroma information that is associated with the video signal but not encoded into the first encoded video signal. Some chroma information could be decoded from both encoded video signals in the case of a combination of 4:2:2/4:2′:2′ coding for example. The second encoder would then be decoding, from the second encoded video signal, chroma information that is not encoded into the first encoded video signal. In an embodiment that uses 4:2:2 coding in combination with 0:4:4 coding, the second encoder could decode all chroma information from the second encoded video signal, including chroma information that is also encoded into the first encoded video signal. Thus, all of the chrominance information associated with the video signal is decoded either from the second encoded video signal by the second decoder, or partially from the first encoded video signal by the first decoder and partially from the second encoded video signal by the second decoder. In either case, full bandwidth chroma information is available.

In a video processing system, a video processor could be operatively coupled to the video decoder, to receive all of the decoded chroma information associated with the video signal, and to use the decoded chroma information in video processing for the video signal. A video keyer such as the full bandwidth chroma keyer 1200 is an example of a video processor. The video processing by the video processor could include alpha generation for video keying, as in the example full bandwidth chroma keyer 1200.

Video coding devices, including encoders and decoders, are described above. Such devices could be used in a video production system such as a virtual set environment, for example. In one embodiment, a full bandwidth chroma camera and a full bandwidth chroma keyer are implemented to enable creation of a virtual reality where talent captured in a monochromatic (typically green or blue) screen environment can be keyed onto different backgrounds with a realism that might not be attainable with limited chroma bandwidth systems and methods.

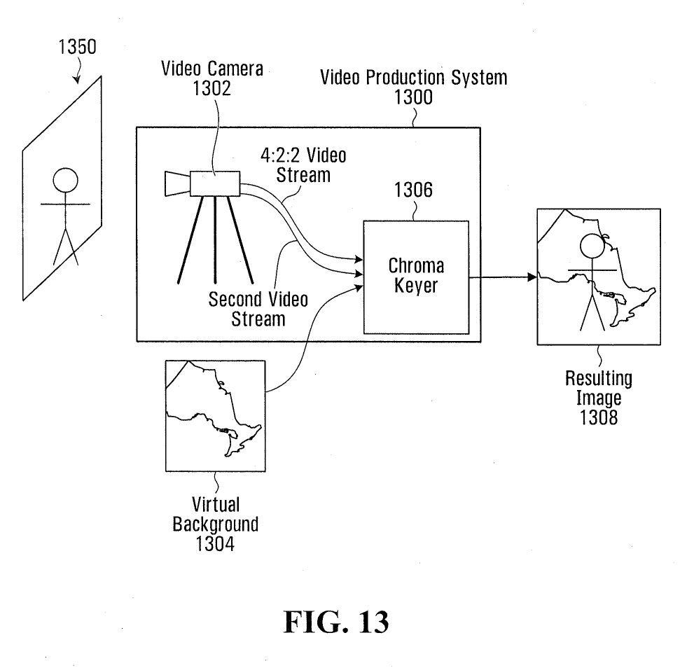

FIG. 13 is a block diagram of an example of such a video production system implementing an embodiment. The example video production system 1300 is similar in structure to the video production system 500 of FIG. 5, and is shown with other elements of a virtual set, including talent on a monochromatic (typically blue or green) screen at 1350, as well as a virtual background 1304 and the resulting image 1308. However, instead of an industry standard 4:2:2 camera 502 and an industry standard limited bandwidth chroma keyer 506, the example video production system of FIG. 5 includes a full bandwidth chroma key system. The talent performs in front of a monochromatic screen at 1350 as in FIG. 5, but the camera 1302 that captures the foreground video is a full bandwidth chroma key camera such as described by way of example with reference to FIG. 11. The 4:2:2 standard encoded video signal and a second encoded video signal, which could be a 0:4:4 full chroma encoded video signal or a 4:2′:2′ encoded video signal for example, are passed to the full bandwidth chroma keyer 1306, an example of which is described with reference to FIG. 12.

Thus, a video production system could include a camera with a video encoder such as the video encoder 1120 shown in FIG. 11, and a video processor operatively coupled to the video camera, to receive a first encoded video signal and a second encoded video signal from the video camera, to decode chroma information from the second encoded video signal, and to use at least the decoded chroma information that is decoded from the second encoded video signal in video processing for the video signal. The chroma keyer 1306 is an example of a video processor.

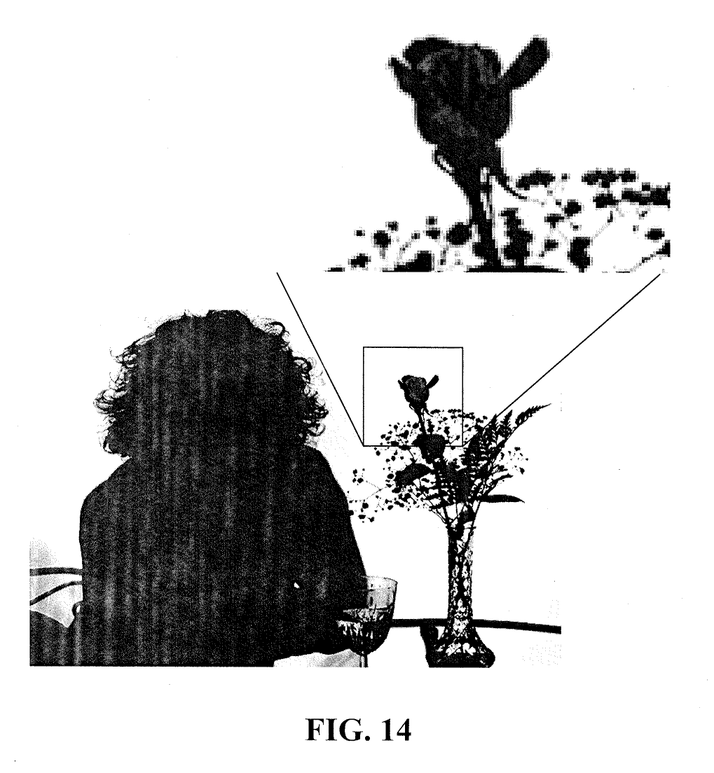

Alpha signals generated using a full bandwidth chroma keyer may have reduced aliasing effects that are common in industry standard, limited bandwidth chroma keyers. This may produce a higher quality result as shown in FIG. 14, which is a representation of a key alpha generated according to an embodiment. FIG. 14 is intended to be illustrative of an alpha generated using a full bandwidth chroma keyer. In this example, details at edges lack the aliasing effects that are shown in FIG. 8 for industry standard, limited bandwidth chroma keyers.

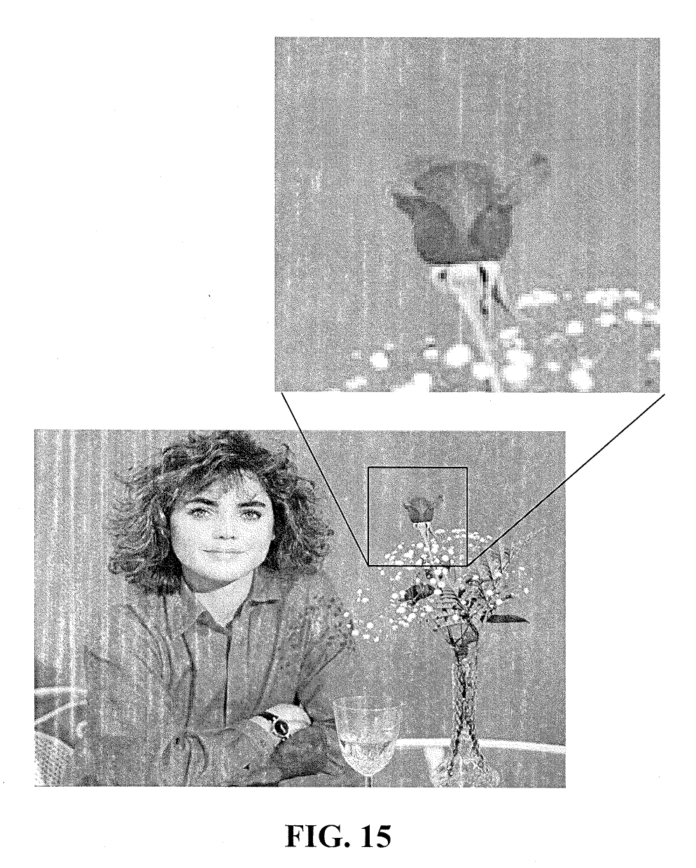

A higher quality alpha may allow the creation of a higher quality final video output. FIG. 15 is a representation of a chroma keying result using the key alpha of FIG. 14. Relative to FIG. 9, FIG. 15 illustrates a dramatic improvement of foreground edges in terms of aliasing effects.

FIGS. 14 and 15 are intended for illustrative purposes only. Similar or different results may be observed in other embodiments.

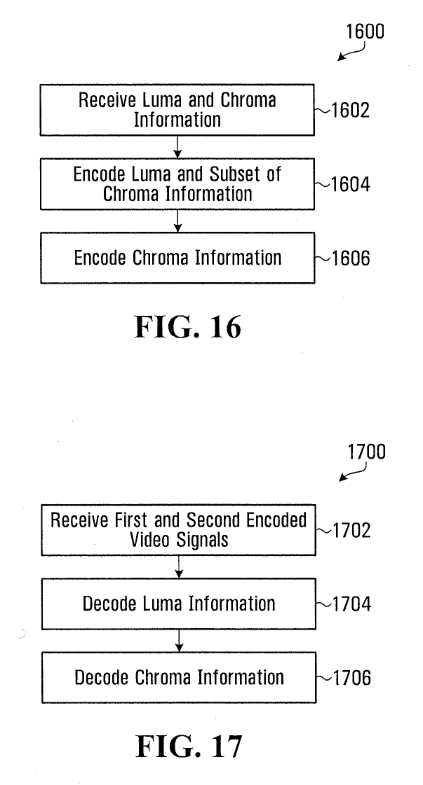

Embodiments are described above primarily in the context of encoded signals and devices. Other embodiments such as methods are also contemplated. FIGS. 16 and 17 are flow charts illustrating example methods.

The example method 1600 includes an operation 1602 of receiving luma information and chroma information that is associated with a video signal. The received luma information and a subset of the received chroma information is encoded at 1604 into a first encoded video signal. The subset of the chroma information includes less than all of the received chroma information. Another encoding operation at 1606 involves encoding chroma information into a second encoded video signal. At least the received chroma information that is not encoded into the first encoded video signal is encoded into the second encoded video signal at 1606. In one embodiment, all of the received chroma information is encoded into the second encoded video signal as in the 0:4:4 example herein. In another embodiment, the remaining chroma information that has not already been encoded into the first encoded video signal is encoded into the second encoded video signal, as in the 4:2′:2′ example herein.

Although shown as serial operations in FIG. 16 for illustrative purposes, the encoding operations at 1604, 1606 could be performed at the same time or at least overlap in time.

The operations at 1602, 1604, 1606 could be performed, for example, by a video camera. Other operations could also be performed by a video camera, such as capturing the video signal and generating the luma information and the chroma information from the video signal.

The example method 1700 includes operations related to processing encoded video signals. At 1702, a first encoded video signal and a second encoded video signal are received. The first encoded video signal has encoded therein luma information associated with a video signal and a subset of chroma information associated with the video signal. The subset of chroma information includes less than all chroma information associated with the video signal. The second encoded video signal has encoded therein at least chroma information that is associated with the video signal but not encoded into the first encoded video signal.

The luma information is decoded from the first encoded video signal at 1704. At 1706, all of the chroma information associated with the video signal is decoded from either from the second encoded video signal, or partially from the first encoded video signal and partially from the second encoded video signal. The second encoded video signal could include all of the chroma information associated with the video signal, in which case the decoding at 1706 involves decoding all of the chroma information from the second encoded video signal.

Although the decoding operations 1704, 1706 are shown a serial operations in FIG. 17, these operations could instead be performed at the same time or at least overlap in time.

In an embodiment, the example method 1700 is implemented in conjunction with additional video processing in which all of the chroma information that is associated with the video signal is used in such video processing for the video signal. The video processing could include alpha generation, video keying, or both, for example.

The example methods 1600, 1700 are illustrative of embodiments. Examples of how operations could be performed and additional operations that may be performed will be apparent from the description and drawings relating to encoded signals and device or apparatus implementations, for example.

The encoding at 1606, for instance, could involve mapping the received chroma information to two data streams, and interlacing the two data streams to generate the second encoded video signal. Another possible option involves mapping the received luma information to a first data stream; mapping, to a second data stream, the received chroma information that is not encoded into the first encoded video signal; and interlacing the first data stream and the second data stream to generate the second encoded video signal.

Additional operations that are not explicitly shown in FIGS. 16 and 17 could include, for example, transmitting the first and second encoded signals from a video source to a video processor, over a serial link or another type of connection or link.

Encoding and decoding operations could be implemented together in a virtual set environment or other type of video production system. Such an implementation could combine the operations shown in FIGS. 16 and 17.

Further variations may be or become apparent.

What has been described is merely illustrative of the application of principles of embodiments of the present disclosure. Other arrangements and methods can be implemented by those skilled in the art.

For example, the present disclosure is not limited to the particular example RGB/Y′CbCr transfer function noted above. Transfer functions for different video formats, such as Standard Definition TeleVision (SDTV) and Ultra-High Definition TeleVision (UHDTV) are also contemplated.

The embodiments shown in the drawings and described above are intended for illustrative purposes. The present disclosure is in no way limited to the particular example embodiments explicitly shown in the drawings and described herein. Other embodiments may include additional, fewer, and/or different device or apparatus components, for example, which are interconnected or coupled together as shown in the drawings or in a different order.

Similar comments also apply in respect of the example methods shown in the drawings and described above. There could be additional, fewer, and/or different operations performed in a similar or different order. For example, not all of the illustrated operations might necessarily be performed in every embodiment. Some embodiments could concentrate on generating just the second encoded video signal, for instance. In this case, chroma information that is associated with a video signal but is not encoded into a first encoded video signal with luma information that is associated with the same video signal could be received and encoded into a second encoded video signal. An encoder could be provided, in a video camera, for example, to encode the chroma information into the second encoded video signal, and corresponding decoding and a decoder could be provided to decode the chroma information.

In addition, although described primarily in the context of signals, devices, systems, or methods, other implementations are also contemplated, as instructions stored on a non-transitory computer-readable medium for execution by a processor, for example. Such instructions, when executed by a processor, cause the processor to perform a method as disclosed herein. The electronic devices described above are examples of a processor that could be used to execute such instructions.

We claim:

1. A video encoder comprising:
an interface to receive luminance information and chrominance information that is associated with a video signal;
a first encoder to encode the received luminance information and a subset of the received chrominance information into a first encoded video signal, the subset of the chrominance information including less than all of the received chrominance information;
a second encoder to encode, into a second encoded video signal, at least the received chrominance information that is not encoded into the first encoded video signal.

2. The video encoder of claim 1, the second encoder being configured to encode all of the received chrominance information into the second encoded video signal.

3. The video encoder of claim 1, the second encoder being configured to map the received chrominance information to two data streams and to interlace the two data streams to generate the second encoded video signal.

4. The video encoder of claim 1, the second encoder being configured to map the received luminance information to a first data stream; to map, to a second data stream, the received chrominance information that is not encoded into the first encoded video signal; and to interlace the first data stream and the second data stream to generate the second encoded video signal.

5. A video camera comprising:
an image detector to capture video image information for the video signal;
a color space converter, operatively coupled to the image detector, to generate luminance information and chrominance information from the video signal;
the video encoder of claim 1, operatively coupled to receive the luminance information and the chrominance information from the color space converter.

6. A video production system comprising:
the video camera of claim 5; and
a video processor, operatively coupled to the video camera, to receive the first encoded video signal and the second encoded video signal from the video camera, to decode chrominance information from the second encoded video signal, and to use the chrominance information that is decoded from the second encoded video signal in video processing for the video signal.

7. The video production system of claim 6, the video processor being further configured to decode chrominance information from the first encoded video signal, and to use the chrominance information that is decoded from the first encoded video signal and the chrominance information that is decoded from the second encoded video signal in the video processing for the video signal.

8. The video production system of claim 6, the video processor comprising a video keyer, and the video processing comprising alpha generation for video keying.

9. A method comprising:
receiving luminance information and chrominance information that is associated with a video signal;
encoding the received luminance information and a subset of the received chrominance information into a first encoded video signal, the subset of the chrominance information including less than all of the received chrominance information;
encoding, into a second encoded video signal, at least the received chrominance information that is not encoded into the first encoded video signal.

10. The method of claim 9, the encoding into a second encoded video signal comprising encoding all of the received chrominance information into the second encoded video signal.

11. The method of claim 9, the encoding into a second encoded video signal comprising:
mapping the received chrominance information to two data streams;
interlacing the two data streams to generate the second encoded video signal.

12. The method of claim 9, the encoding into a second encoded video signal comprising:
mapping the received luminance information to a first data stream;
mapping, to a second data stream, the received chrominance information that is not encoded into the first encoded video signal;
interlacing the first data stream and the second data stream to generate the second encoded video signal.

13. The method of claim 9, further comprising:
capturing the video signal;
generating the luminance information and the chrominance information from the video signal.

14. The method of claim 9, further comprising:
receiving the first encoded video signal and the second encoded video signal;
decoding chrominance information from the second encoded video signal;
using the chrominance information that is decoded from the second encoded video signal in video processing for the video signal.

15. The method of claim 14, further comprising:
decoding chrominance information from the first encoded video signal,
the using comprising using the chrominance information that is decoded from the first encoded video signal and the chrominance information that is decoded from the second encoded video signal in the video processing for the video signal.

16. The method of claim 14, the video processing comprising alpha generation for video keying.

17. A non-transitory computer-readable medium storing instructions which when executed by a processor cause the processor to perform the method of claim 9.

18. A video decoder comprising:
an interface to receive a first encoded video signal and a second encoded video signal, the first encoded video signal having encoded therein luminance information associated with a video signal and a subset of chrominance information associated with the video signal, the subset of chrominance information including less than all chrominance information associated with the video signal, the second encoded video signal having encoded therein at least chrominance information that is associated with the video signal but not encoded into the first encoded video signal;
a first decoder, operatively coupled to the interface, to decode at least the luminance information from the first encoded video signal;
a second decoder, operatively coupled to the interface, to decode from the second encoded video signal at least the chrominance information that is associated with the video signal but not encoded into the first encoded video signal,
wherein all of the chrominance information associated with the video signal is decoded either from the second encoded video signal by the second decoder, or partially from the first encoded video signal by the first decoder and partially from the second encoded video signal by the second decoder.

19. The video decoder of claim 18,
the second encoded video signal having encoded therein all of the chrominance information that is associated with the video signal,
the second decoder being configured to decode all of the chrominance information that is associated with the video signal from the second encoded video signal.

20. A video processing system comprising:
the video decoder of claim 18;
a video processor, operatively coupled to the video decoder, to receive all of the chrominance information associated with the video signal, and to use the decoded chrominance information that is associated with the video signal in video processing for the video signal.

21. The video processing system of claim 20, the video processor comprising a video keyer, and the video processing comprising alpha generation for video keying.

22. A method comprising:
receiving a first encoded video signal and a second encoded video signal, the first encoded video signal having encoded therein luminance information associated with a video signal and a subset of chrominance information associated with the video signal, the subset of chrominance information including less than all chrominance information associated with the video signal, the second encoded video signal having encoded therein at least chrominance information that is associated with the video signal but not encoded into the first encoded video signal;
decoding the luminance information from the first encoded video signal;
decoding all of the chrominance information associated with the video signal from either from the second encoded video signal, or partially from the first encoded video signal and partially from the second encoded video signal.

23. The method of claim 22,
the second encoded video signal having encoded therein all of the chrominance information that is associated with the video signal,
decoding all of the chrominance information comprising decoding all of the chrominance information from the second encoded video signal.

24. The method of claim 22, further comprising:
using all of the chrominance information that is associated with the video signal in video processing for the video signal.

25. The method of claim 24, the video processing comprising alpha generation for video keying.

26. A method comprising:
receiving chrominance information that is associated with a video signal but is not encoded into a first encoded video signal with luminance information that is associated with the video signal;
encoding the received chrominance information into a second encoded video signal.
